(19) United States
(12) Patent Application Publication
(10) Pub. No.: US 2014/0110446 A1
(43) Pub. Date: Apr. 24, 2014

(54) Apparatus for holding an item within a vehicle and methods of using the same

(71) Applicant: Tracy Carter, Bloomingdale, IL (US)

(72) Inventor: Tracy Carter, Bloomingdale, IL (US)

(21) Appl. No.: 13/654,530

(22) Filed: Oct. 18, 2012

(51) Int. Cl. B60R 7/00

(52) U.S. Cl. 224/275

(57) ABSTRACT

An apparatus holds items on a backrest of a seat of an automobile. Specifically, the apparatus comprises a hook or other attachment means for hooking or otherwise attaching the apparatus to a head rest of a car seat. Moreover, the apparatus comprises an extended portion extending from the hook or other attachment means, and a scoop portion forming a surface for holding a handle of an item, such as a bag, a purse, an umbrella, a backpack, or other like item. Methods of using the same are further provided.

The present invention claims priority to U.S. Provisional Patent Application No. 61/653,378, entitled, “P.S. (Purse Scooper)”, filed May 30, 2012, hereby incorporated by reference in its entirety.

### TECHNICAL FIELD

The present invention relates to an apparatus for holding items on a backrest of a seat of an automobile. Specifically, the apparatus comprises a hook or other attachment means for hooking or otherwise attaching the apparatus to a head rest of a car seat. Moreover, the apparatus comprises an extended portion extending from the hook or other attachment means, and a scoop portion forming a surface for holding a handle of an item, such as a bag, a purse, an umbrella, a backpack, or other like item. Methods of using the same are further provided.

### BACKGROUND

It is, of course, generally known to transport items within automobiles. Typically, a driver may hold an item in his or her hand and enter the driver's side of the automobile, placing the item on the front passenger seat. The item may typically be a bag, such as a purse, a grocery bag, a backpack, an umbrella, or another item. In many cases, the bag may include items that the driver may wish to access during the operation of the automobile. A need, therefore, exists for an apparatus and methods of using the same allowing for quick and easy access to an item, such as a bag or the like, within a vehicle while operating the vehicle.

Typically, when placed on the passenger seat, an item may not be secure, especially during operation of the vehicle. In many cases, the item may slide or otherwise move on the seat, especially during starting, stopping or turning. For example, sudden turns or stoppages may cause an item to slide on the seat. In addition, the item may tip, spilling its contents onto the seat or the floor. Even if the item is closed, the movement or tipping thereof may cause the contents to become disorganized. A need, therefore, exists for an apparatus and methods of using the same that secures items within an automobile during operation thereof. A need further exists for an apparatus and methods of using the same that secures an item in a proper orientation within a vehicle, and maintains that orientation during operating of the vehicle such as during starts, stops and turns.

In addition, there may already be items on the passenger seat, and placement of an additional item on the passenger seat may be difficult if not impossible. A need, therefore, exists for an apparatus and methods of using the same allowing for additional holding and storage space within an automobile for items.

Still further, apparatuses for holding items within automobiles should be relatively inconspicuous so as not to be readily seen by users or by others. A need, therefore, exists for an apparatus and methods of using the same whereby the apparatus maintains an inconspicuous profile.

### SUMMARY OF THE INVENTION

The present invention relates to an apparatus for holding items on a backrest of a seat of an automobile. Specifically, the apparatus comprises a hook or other attachment means for hooking or otherwise attaching the apparatus to a head rest of a car seat. Moreover, the apparatus comprises an extended portion extending from the hook or other attachment means, and a scoop portion forming a surface for holding a handle of an item, such as a bag, a purse, an umbrella, a backpack, or other like item. Methods of using the same are further provided.

To this end, in an embodiment of the present invention, an apparatus for holding an item on a vehicle seat, the apparatus comprising: a first end comprising an attachment for attaching to a post of a headrest of a vehicle seat; an extended portion extending from the attachment; and a scoop portion extending downwardly from the extended portion, the scoop portion comprising a descending portion and an ascending portion, and having a portion between the descending portion and the ascending portion for holding an item thereon.

In an embodiment, the attachment comprises an open hook.

In an embodiment, the attachment comprises a closed hook.

In an embodiment, the extended portion has a length generally spanning the distance between the post of the vehicle seat and a front of a vehicle seat.

In an embodiment, the portion between the descending portion and the ascending portion is curved.

In an embodiment, the portion between the descending portion and the ascending portion is angled.

In an embodiment, the portion between the descending portion and the ascending portion is a surface, wherein an item is held on the surface.

In an alternate embodiment of the present invention, a system for holding an item in a vehicle is provided. The system comprises an apparatus for holding an item on a vehicle seat, the apparatus comprising a first end comprising an attachment for attaching to a post of a headrest of a vehicle seat, an extended portion extending from the attachment, and a scoop portion extending downwardly from the extended portion, the scoop portion comprising a descending portion and an ascending portion, and having a portion between the descending portion and the ascending portion for holding an item thereon; and a vehicle seat having a back rest, a head rest, and a post connecting the back rest to the head rest, wherein the apparatus is attached to the post by the attachment.

In an embodiment, the attachment comprises an open hook.

In an embodiment, the attachment comprises a closed hook.

In an embodiment, the extended portion has a length generally spanning the distance between the post of the vehicle seat and a front of a vehicle seat.

In an embodiment, the portion between the descending portion and the ascending portion is curved.

In an embodiment, the portion between the descending portion and the ascending portion is angled.

In an embodiment, the portion between the descending portion and the ascending portion is a surface, wherein an item is held on the surface.

In an embodiment, the system further comprises an item resting upon the portion between the descending portion and the ascending portion.

In an embodiment, the item has a handle, wherein the handle rests upon the portion between the descending portion and the ascending portion.

In an alternate embodiment of the present invention, a method of using an apparatus for holding an item in a vehicle is provided. The method comprises the steps of: providing an apparatus for holding an item on a vehicle seat, the apparatus comprising a first end comprising an attachment for attaching to a post of a headrest of a vehicle seat, an extended portion extending from the attachment, and a scoop portion extending downwardly from the extended portion, the scoop portion comprising a descending portion and an ascending portion, and having a portion between the descending portion and the ascending portion for holding an item thereon; providing a vehicle seat having a back rest, a head rest, and a post connecting the back rest to the head rest; and attaching the apparatus to the post by the attachment.

In an embodiment, the method further comprises placing an item on the portion between the descending portion and the ascending portion of the apparatus.

In an embodiment, the portion between the descending portion and the ascending portion is curved.

In an embodiment, the portion between the descending portion and the ascending portion is angled.

It is, therefore, an advantage and objective of the present invention to provide an apparatus and methods of using the same allowing for quick and easy access to an item, such as a bag or the like, within a vehicle while operating the vehicle.

It is further an advantage and objective of the present invention to provide an apparatus and methods of using the same that secures items within an automobile during operation thereof.

Moreover, it is an advantage and objective of the present invention to provide an apparatus and methods of using the same that secures an item in a proper orientation within a vehicle, and maintains that orientation during operating of the vehicle such as during starts, stops and turns.

Further, it is an advantage and objective of the present invention to provide an apparatus and methods of using the same allowing for additional holding and storage space within an automobile for items.

Still further, it is an advantage and objective of the present invention to provide an apparatus and methods of using the same whereby the apparatus maintains an inconspicuous profile.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of an apparatus for holding items on an automobile seat in an embodiment of the present invention.

FIG. 2 illustrates a side view of an apparatus for holding items on an automobile seat in an embodiment of the present invention.

FIG. 3 illustrates a front view of an apparatus for holding items on an automobile seat in an embodiment of the present invention.

FIG. 4 illustrates an apparatus attached to an automobile seat for holding items thereon in an embodiment of the present invention.

FIG. 5 illustrates an apparatus attached to an automobile seat holding a purse in an embodiment of the present invention.

### DETAILED DESCRIPTION OF THE PRESENTLY PREFERRED EMBODIMENTS

The present invention relates to an apparatus for holding items on a backrest of a seat of an automobile. Specifically, the apparatus comprises a hook or other attachment means for hooking or otherwise attaching the apparatus to a head rest of a car seat. Moreover, the apparatus comprises an extended portion extending from the hook or other attachment means, and a scoop portion forming a surface for holding a handle of an item, such as a bag, a purse, an umbrella, a backpack, or other like item. Methods of using the same are further provided.

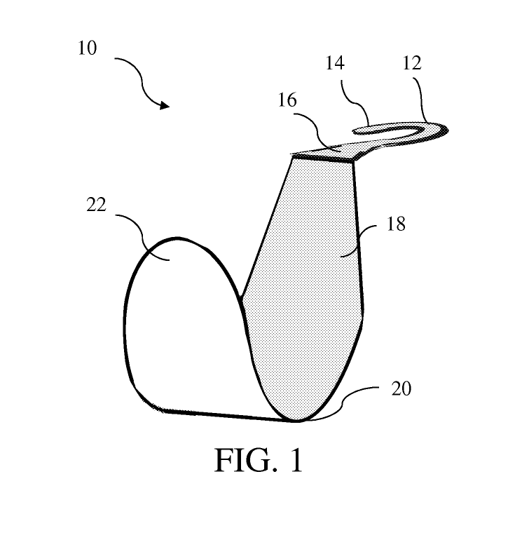

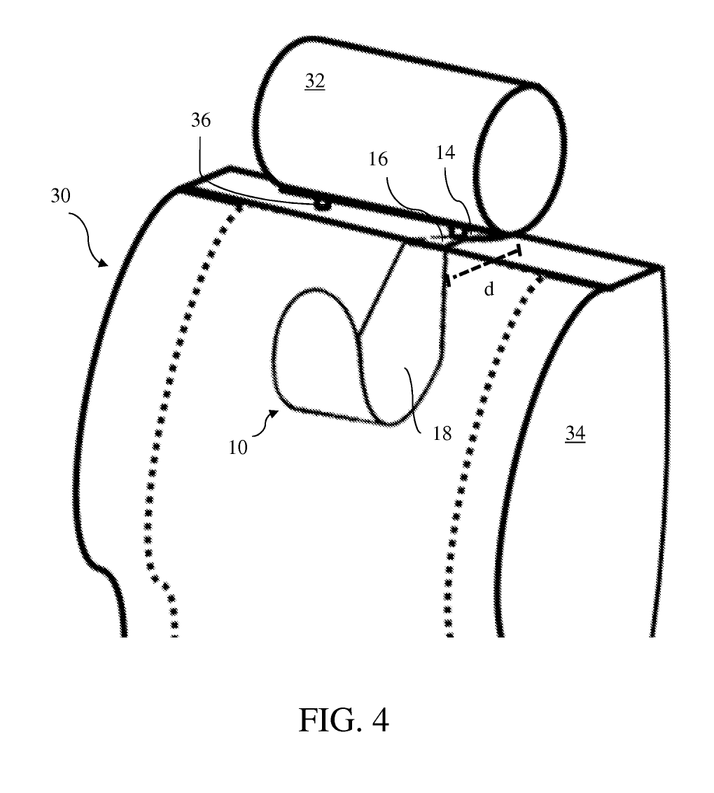

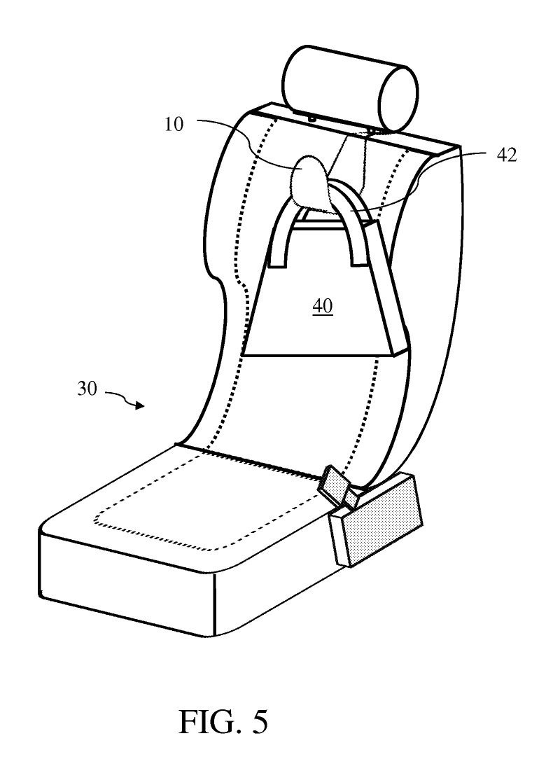

Now referring to the figures, wherein like numerals refer to like parts, FIG. 1 illustrates an apparatus 10 for holding items on an automobile seat, as described in more detail below with respect to FIGS. 4 and 5. Specifically, the apparatus 10 comprises a first end 12 having a hook 14 thereon, or other attachment means. The hook 14 may engage the post holding a headrest on a top of a passenger seat, as illustrated in more detail below. Although the present invention shows the hook 14 as being open, it should be noted that a closed hook may also be used, such as a karabiner or other means for attaching to a post holding a headrest on a top of a passenger seat.

The apparatus 10 may further have an extended portion 16 extending from the first end 12. The extended portion 16 may extend a distance from the first end 12, the distance relating to the general distance between the post of a head rest extending from a car seat, and the front of the car seat. The extended portion 16 may connect to a downwardly disposed scoop portion 18 that may, generally, extend downwardly toward a curve 20 and then extend upwardly towards a second end 22 where the scoop portion 18 may terminate. The scoop portion 18 may hold one or more handles of items, such as a bag, a purse, or other like item, thereon.

Although the scoop portion 18 is generally shown, in FIGS. 1-5, as a curved element, it should be noted that an angled element may be provided as well as long as the scoop portion 18 allows handles of items to rest thereon and to be held in place thereon. The second end 22 may extend upwardly a sufficient distance to ensure that the handles of an item held thereon do not dislodge from the scoop portion 18, such as during periods of hard braking or turning of a vehicle or the like.

Preferably, the apparatus 10 may be made from any rigid, resilient material apparent to one of ordinary skill in the art, such as wood, metal, plastic, or the like. Preferably, the apparatus 10 may be made of aluminum, which provides sufficient strength to hold an item thereon, but may be light enough and have a small enough size to be inconspicuous when in use.

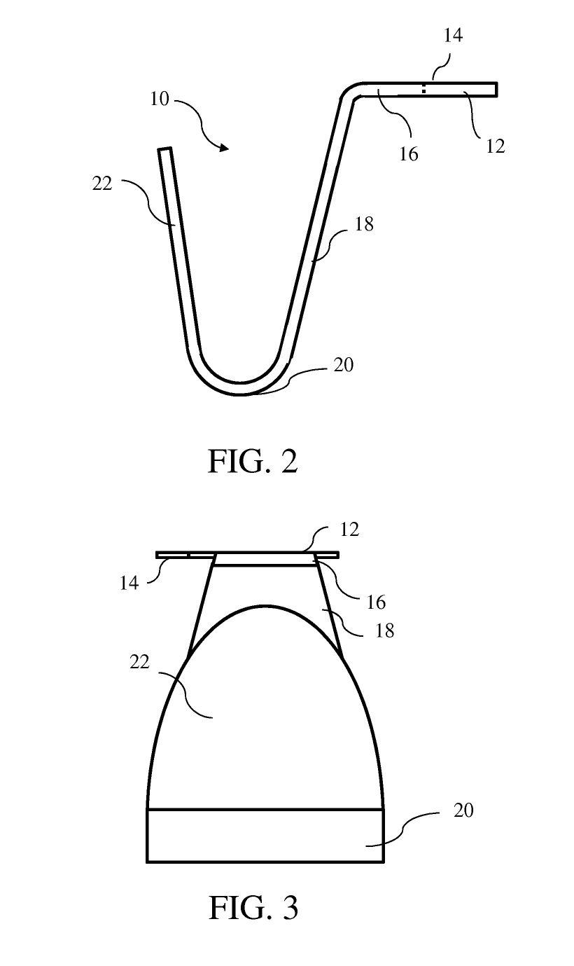

Now referring to FIG. 2, a side view of the apparatus 10 is shown and described, showing a profile of the apparatus. As illustrated, the apparatus 10 may comprise the first end 12 having the hook 14 or other attachment means. Extending from the first end 12 may be the extended portion 16, connected to the scoop portion 18, which may include the curved portion 20 and second end 22. The apparatus 10 may have a thickness sufficient to provide the strength necessary to resiliently hold an item thereon when in use, as illustrated in FIG. 5, and described below.

FIG. 3 illustrates a front view of the apparatus 10, illustrating the second end 22 terminating from the curved portion 20 and extending upwardly toward the extended portion 16 and the first end 12 with the hook 14. In a preferred embodiment, the second end 22 of the apparatus may be curved, and lack any sharp edges that may be dangerous, especially within an automobile during operation, although the present invention should not be limited as described herein.

FIG. 4 illustrates an apparatus 10 in use on an automobile seat 30. Specifically, a headrest 32 extending from the top of an automobile back rest 34 may have a post 36, whereupon the apparatus 10 may attach. The hook 14 of the apparatus, specifically, may engage the post 36 extending from the back rest 34. The extended portion 16 may extend approximately the distance from the post 36 to the front of the back rest 34, whereupon the scoop portion 18 may descend. Thus, the distance “-d-” from the post 36 to the front of the back rest 34 of the seat may be approximately the same as the length of the extended portion 16 of the apparatus 10. The scoop portion 18 may clear the top of the back rest 34 before descending to offer a surface for holding an item.

As shown in FIG. 5, the scoop portion 18 may provide the surface to hold an item, such as a purse 40. Specifically, a handle 42 of the purse 40 may loop and rest upon the scoop portion 18 of the apparatus 10, holding the handle and, thus, the purse, in a secured position above the seat 30. Thus, the purse 40 may be easily accessible by a driver of the automobile or another passenger. Moreover, the purse 40 may be held securely such that any movement of the vehicle during operation thereof will not disturb the contents of the purse 40. Of course, it should be noted that any other item may be held on the apparatus 10 as apparent to one of ordinary skill in the art, and the invention should not be limited as described herein.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. An apparatus for holding an item on a vehicle seat, the apparatus comprising:
a first end comprising an attachment for attaching to a post of a headrest of a vehicle seat;
an extended portion extending from the attachment; and
a scoop portion extending downwardly from the extended portion, the scoop portion comprising a descending portion and an ascending portion, and having a portion between the descending portion and the ascending portion for holding an item thereon.

2. The apparatus of claim 1 wherein the attachment comprises an open hook.

3. The apparatus of claim 1 wherein the attachment comprises a closed hook.

4. The apparatus of claim 1 wherein the extended portion has a length generally spanning the distance between the post of the vehicle seat and a front of a vehicle seat.

5. The apparatus of claim 1 wherein the portion between the descending portion and the ascending portion is curved.

6. The apparatus of claim 1 wherein the portion between the descending portion and the ascending portion is angled.

7. The apparatus of claim 1 wherein the portion between the descending portion and the ascending portion is a surface, wherein an item is held on the surface.

8. A system for holding an item in an vehicle comprising:
an apparatus for holding an item on a vehicle seat, the apparatus comprising a first end comprising an attachment for attaching to a post of a headrest of a vehicle seat, an extended portion extending from the attachment, and a scoop portion extending downwardly from the extended portion, the scoop portion comprising a descending portion and an ascending portion, and having a portion between the descending portion and the ascending portion for holding an item thereon; and
a vehicle seat having a back rest, a head rest, and a post connecting the back rest to the head rest, wherein the apparatus is attached to the post by the attachment.

9. The system of claim 8 wherein the attachment comprises an open hook.

10. The system of claim 8 wherein the attachment comprises a closed hook.

11. The system of claim 8 wherein the extended portion has a length generally spanning the distance between the post of the vehicle seat and a front of a vehicle seat.

12. The system of claim 8 wherein the portion between the descending portion and the ascending portion is curved.

13. The system of claim 8 wherein the portion between the descending portion and the ascending portion is angled.

14. The system of claim 8 wherein the portion between the descending portion and the ascending portion is a surface, wherein an item is held on the surface.

15. The system of claim 8 further comprising:
an item resting upon the portion between the descending portion and the ascending portion.

16. The system of claim 15 wherein the item has a handle, wherein the handle rests upon the portion between the descending portion and the ascending portion.

17. A method of using an apparatus for holding an item in an vehicle comprising the steps of:
providing an apparatus for holding an item on a vehicle seat, the apparatus comprising a first end comprising an attachment for attaching to a post of a headrest of a vehicle seat, an extended portion extending from the attachment, and a scoop portion extending downwardly from the extended portion, the scoop portion comprising a descending portion and an ascending portion, and having a portion between the descending portion and the ascending portion for holding an item thereon;
providing a vehicle seat having a back rest, a head rest, and a post connecting the back rest to the head rest; and
attaching the apparatus to the post by the attachment.

18. The method of claim 17 further comprising:
placing an item on the portion between the descending portion and the ascending portion of the apparatus.

19. The method of claim 17 wherein the portion between the descending portion and the ascending portion is curved.

20. The method of claim 17 wherein the portion between the descending portion and the ascending portion is angled.
